(19) United States
(12) Patent Application Publication
(10) Pub. No.: US 2008/0210235 A1
(43) Pub. Date: Sep. 4, 2008

(54) Intubation detector

(75) Inventors: Stephen James Field, Bridge (GB); Eric Pagan, Hythe (GB); Neil Adam Tookman, Stanmore (GB)

Correspondence Address: LOUIS WOO;LAW OFFICE OF LOUIS WOO, 717 NORTH FAYETTE STREET, ALEXANDRIA, VA, 22314, US

(73) Assignee: Smiths Group plc, London (GB)

(21) Appl. No.: 11/819,268

(22) Filed: Jun. 26, 2007

(30) Foreign Application Priority Data
Jun. 28, 2006 (GB) 0612750.0

(51) Int. Cl. A62B 27/00

(52) U.S. Cl. 128/202.22

(57) ABSTRACT

An intubation detector for an endotracheal tube has a resilient bellows and a carbon dioxide, color-change indicator mounted at the machine end of the tube. Compressing and releasing the bellows indicates whether or not the patient end of the tube is occluded. When the patient end of the tube is not occluded, gas is drawn into the indicator by the bellows to provide an indication of carbon dioxide level. The detector may be mounted at the machine end of a stiff introducer tube extended along the endotracheal tube. Alternatively, the detector may be mounted by a stem directly into the bore at the machine end of the endotracheal tube.

### BACKGROUND OF THE INVENTION

This invention relates to intubation detectors.

The invention is more particularly concerned with detectors for detecting correct placement of an endotracheal tube.

One of the major problems associated with the use of an endotracheal tube is that of ensuring that the patient end of the tube is correctly located in the trachea and not in the oesophagus. There are various ways in which correct intubation can be detected. The usual way is to connect the machine end of the tube to a capnograph, which is responsive to the levels of carbon dioxide in gas emerging from the tube. When the tube is correctly inserted, the level of carbon dioxide detected rises and falls with the patient's breathing. By detecting this alternating level of carbon dioxide, correct intubation is indicated. If the tube is incorrectly inserted, in the oesophagus, any carbon dioxide produced by the digestive system will be at a relatively steady level. Capnographs can produce a reliable indication of correct intubation but the equipment is relatively bulky and expensive so it is only available in well-equipped surgical operating theatres.

An alternative device can be used to detect carbon dioxide, which includes a chemical color-change or calorimetric indicator, such as described in, for example, WO96/24054, EP509998, U.S. Pat. Nos. 5,005,572, 4,879,999, EP257916, U.S. Pat. Nos. 4,691,701, 4,790,327, WO89/07956, GB2218515, U.S. Pat. Nos. 6,378,522 and 4,728,499. This form of device usually comprises a paper or some other substrate that is impregnated or coated with the chemical including a pH-sensitive indicator dye, the substrate preferably being provided in some form of transparent connector attached to the machine end of the tube. Such indicators can be of low cost and can provide a clear indication that the tube has been correctly inserted. If the indicator fails to change color, the clinician knows immediately that the tube has been incorrectly inserted.

An alternative arrangement to detect correct intubation involves a resilient bellows connected to the machine of the tube. This is held compressed against its resilience while the tube is being inserted and is released when the user believes the patient end of the tube is in the correct position. If the tube is correctly inserted in the trachea, the bellow will immediately expand. If, however, the patient end of the tube is located incorrectly, in the oesophagus, the bellows will remain contracted, with a vacuum or negative pressure within the bellows. This is because the soft nature of the tissue lining the oesophagus enables the tissue to contact and occlude gas passage into the end of the tube. Intubation detectors of this kind are sold by Paraproducts of South Elgin, Ill., USA under the trademark “Positube” and by Ambu Inc of Linthicum, Md., USA under the trademark “TubeChek”

Although these two different techniques, that is detection of carbon dioxide and vacuum occlusion, are useful and widely used, neither is totally reliable. There exists, therefore, a need for an intubation detector having increased reliability.

### BRIEF SUMMARY OF THE INVENTION

It is an object of the present invention to provide an alternative intubation detector and method.

According to one aspect of the present invention there is provided an intubation detector arranged for mounting with a tracheal tube, the detector including pump means arranged towards the machine end of the tube to apply a negative pressure to the tube and to indicate when gas fills the pump means from the patient end of the tube, and the detector including carbon dioxide indicator means arranged to provide an indication of the presence of carbon dioxide in gas drawn into the tube by the pump means.

The pump means is preferably a resilient manual device, such as including a bellows. The resilient manual device preferably has a natural expanded state such that when released it tends to draw gas into the detector. The carbon dioxide indicator means preferably includes a color-change indicator. The detector may include an inlet tube adapted to extend along the bore of a tracheal tube substantially to its patient end. The inlet tube is preferably a stiff or malleable introducer tube. Alternatively, the detector may have a stem adapted to fit in the machine end of an endotracheal tube.

According to another aspect of the present invention there is provided an assembly of an endotracheal tube and an intubation detector according to the above one aspect of the invention.

According to a further aspect of the present invention there is provided a method of detecting correct intubation of a tracheal tube including the steps of applying a negative pressure to the tube when in position, monitoring the response to the negative pressure to determine whether the patient end of the tube is open or occluded, and monitoring the response of a carbon dioxide detector to see if it indicates the presence of carbon dioxide at levels found in exhaled breath.

The negative pressure is preferably applied by releasing a resilient member. The carbon dioxide detector may be monitored for a change in color. The carbon dioxide detector and means for applying negative pressure may be mounted with an introducer extending within the tracheal tube, the introducer being removed from the tube following confirmation of correct intubation.

An assembly of an endotracheal tube and intubation detector according to the present invention will now be described, by way of example, with reference to the accompanying drawings.

### BRIEF DESCRIPTION OF THE DRAWINGS

FIG. 1 is a side elevation view of one form of the assembly;

FIG. 2 is an enlarged cross-sectional side elevation of a part of the assembly of FIG. 1;

FIG. 3 is a perspective view of a part of an alternative assembly;

FIG. 4 is a cross-sectional view of the part in FIG. 3; and

FIG. 5 is a perspective view of a further alternative assembly.

### DETAILED DESCRIPTION OF THE PREFERRED EMBODIMENTS

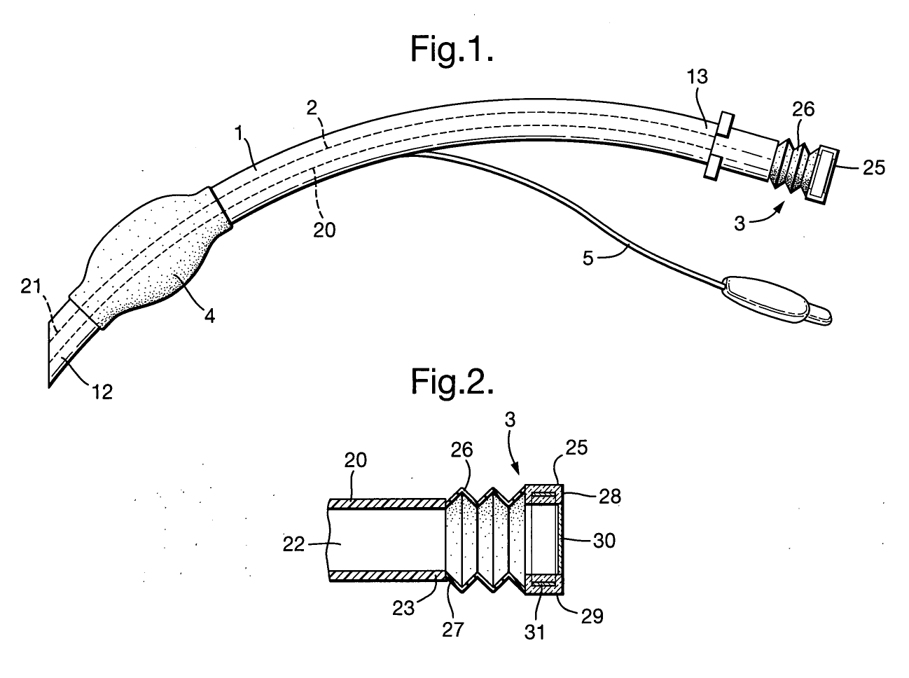

With reference first to FIGS. 1 and 2 there is shown an assembly of a conventional endotracheal tube 1 and a combined introducer and intubation detector 2. The endotracheal tube 1 is curved along its length from its patient end 12 to its machine end 13. A sealing cuff 4 surrounds the shaft of the tube close to its patient end 12 and this is inflated and deflated, in the usual way, via an inflation lumen and inflation line 5. The introducer 2 comprises a hollow inlet tube 20, which may be stiff or malleable so that the tube 1 can be bent to the desired shape for intubation. The introducer tube 20 extends to the patient end 12 of the endotracheal tube 1 as a close sliding fit so that there is an effective gas seal between the outside of the introducer tube and the inside of the endotracheal tube. At its patient end 21, the introducer tube 20 is open so that gas can flow into the bore 22 of the tube. At its machine end 23, the tube 20 is closed by the intubation detector 3 provided by manual pump means 26 and a carbon dioxide indicator 25. The pump means takes the form of a resilient, annularly pleated bellows 26 of cylindrical shape sealed at its forward end 27 to the rear end 23 of the introducer tube 20. The rear end of the bellows 26 is closed against gas escape by the carbon dioxide indicator 25, which has a housing 28 formed of a circular annulus 29 with a central disc 30. The annulus 29 and disc 30 are of a transparent plastics material, the annulus containing a color-change carbon dioxide indicator such as a chemically-treated paper element 31 of any well-known kind and of annular shape. The paper element 31 is exposed on one or both sides to gas within the bellows 26 and is visible through the housing 28. The disc 30 supports a color-comparison plate against which the color of the color change annulus 29 can be compared. The nature of the bellows 26 is such that it has a natural expanded state. When it is squeezed axially to compress the pleats, the internal volume is reduced and air is pumped out of the bellows and into the introducer tube 20. When the bellows 26 is released, its resilience tends to make it resume its original shape so it expands axially to its original length and, as it does so, it sucks gas into the detector from the introducer tube 20.

The assembly of the tube 1 and introducer 2 is introduced in the usual way into the trachea. While this is being done, the clinician keeps his thumb pressed down on the bellows 26 to keep it contracted, against its resilience. When the clinician believes the patient end 2 of the tube 1 is correctly inserted, he released the bellows 26 and monitors what happens. If the tube 1 is correctly inserted in the trachea, the bellows 26 will expand to its normal size and gas from the patient's respiratory tract will be sucked by the bellows 26 up the introducer 2 and into the bellows so as to expose the carbon dioxide indicator 25 to the gas. The indicator 25 will change from its usual color (caused by exposure to atmospheric air with relatively low levels of carbon dioxide) to a different color to indicate a higher carbon dioxide level characteristic of exhaled breath and correct tracheal intubation. The clinician can then pull out the introducer 2 from the endotracheal tube 1 and ventilate the patient in the usual way as necessary, or leave the machine end 13 open if the patient is breathing spontaneously.

If, however, the patient end 12 of the endotracheal tube 1 is incorrectly located, in the oesophagus, this will cause two different effects. First, the bellows 26 will not expand to its original shape, or will only do so at a much slower rate. This is because the soft, constricted nature of the tissue of the oesophagus will close about the angled end tip 12 of the endotracheal tube 1 and block it, thereby preventing gas entering the introducer tube 20 and preventing the negative pressure (that is, pressure below atmospheric pressure) in the bellows being relieved. The clinician, therefore, sees little change in the shape of the bellows 26 when it is released. The second effect is that the carbon dioxide indicator 25 will not be exposed to elevated levels of carbon dioxide in expiratory gas so there will be no change of color of the indicator. If the clinician sees either or both of these situations he withdraws the endotracheal tube 1 and tries inserting it again. It should be noted that the carbon dioxide indicator 25 will also give a negative indication when the tube is correctly inserted but the patient is not breathing.

The intubation detector 3, therefore provides two different, independent confirmations of correct or incorrect placement. In this way, the reliability and confidence provided by the detector is enhanced compared with conventional intubation detectors. The intubation detector 3 of the present invention also gives an indication of correct intubation when the patient is not breathing, which is not possible with a simple carbon dioxide indicator alone. With a conventional carbon dioxide indicator a clinician could interpret a negative indication (low CO2 indication) as meaning that the tube was correctly inserted but the patient was not breathing. The bellows 26 sucks gas into it when the end of the introducer 2 is open, thereby leading to rapid exposure of the carbon dioxide indicator 25 to the gas at the tip of the tube. This ensures a quick color response.

Instead of providing the detector on an introducer, as described above, it could be provided directly on the tracheal tube itself.

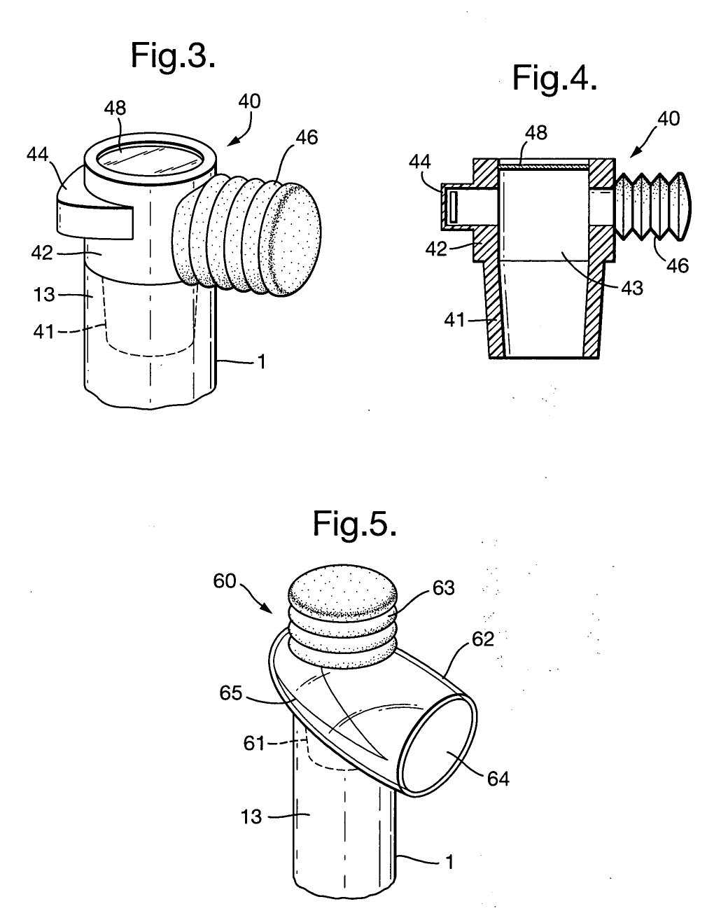

FIGS. 3 and 4 show an arrangement where the intubation detector 40 provides as a 15 mm connector removably plugged into the machine end 13 of the endotracheal tube 1. The detector 40 has a tapered coupling stem 41 at one end adapted to make a secure sealing fit in the tube. The stem 41 continues as a cylindrical portion 42 having an open interior 43 with an internal standard taper to receive a 15 mm male connector. The cylindrical portion 42 supports a calorimetric or other carbon dioxide indicator 44 on one side and exposed to gas within the interior 43 of the cylindrical portion. A bellows 46 of the same kind as in the previous embodiment is connected to the cylindrical portion 42 and extends orthogonally to its axis, diametrically opposite the indicator 44. The upper, rear or machine end of the cylindrical portion 42 is open but is closed temporarily by a rupturable seal 48 or sealing end cap so that a 15 mm male connector can be inserted to make a mating connection with the interior of the cylindrical portion while also sealing off the bellows 46. The intubation detector 40 shown in FIGS. 3 and 4 can be connected to the machine end 13 of the endotracheal tube 1 after it has been inserted in the patient in the usual way to confirm correct placement by monitoring both the color of the indicator 44 and the expansion of the bellows 46. The bellows 46 can be pressed in after placement of the tube 1 even if the patient end of the tube is located in the oesophagus. The tissue of the oesophagus can be displaced away from the patient end 12 of the tube 1 by the elevated pressure created by compression of the bellows 46 but the negative pressure created by the initial expansion of the bellows sucks the tissue into closer contact with the end of the tube. The indicator 40 can be left in place after correct intubation has been confirmed or it may be removed.

FIG. 5 shows a further alternative assembly of a detector 60 on the tube 1. The detector 60 has a tapered stem 61 pushed into the machine end 13 of the tube 1 in the same way as the detector in FIGS. 3 and 4. The main body 62 of the detector is transparent and extends at right angles to the stem 61, being rotatably mounted on the stem for rotation about the axis of the stem. A bellows 63 is arranged axially of the stem 61. The body 62 has a side port 64 arranged at right angles to the stem 61 by which connection can be made to a ventilation circuit or left open to atmosphere where the patient is breathing spontaneously. The carbon dioxide indicator 65 is mounted in the body 62 directly opposite the side port 63. As in the detector of FIGS. 3 and 4, the side port 64 is closed during use of the bellows 63 such as by means of a rupturable seal or removable cap or the like.

There are various different ways in which carbon dioxide can be detected instead of using a calorimetric indicator. For example, the companies NanoMix Inc, Ion Optics Inc, Asthma Alert Ltd and Smart Holograms offer alternative technologies. Although the bellows arrangement provides a simple, low cost pumping means and indicator, it would be possible to use alternative pumping arrangements such as a syringe-like device with a piston urged rearwardly in a barrel by a spring.

What we claim is:

1. An intubation detector arranged for mounting with a tracheal tube, wherein the detector comprises: a pump, said pump being arranged towards the machine end of said tube to apply a negative pressure to said tube and to indicate when gas fills said pump from a patient end of said tube; and a carbon dioxide indicator, said carbon dioxide indicator being arranged to provide an indication of presence of carbon dioxide in gas drawn into said tube by said pump.

2. An intubation detector according to claim 1, wherein said pump is a resilient manual device.

3. An intubation detector according to claim 2, wherein said resilient manual device includes a bellows.

4. An intubation detector according to claim 2, wherein said resilient manual device has a natural expanded state such that when released it tends to draw gas into the detector.

5. An intubation detector according to claim 1, wherein said carbon dioxide indicator includes a color-change indicator.

6. An intubation detector according to claim 1, wherein the detector includes an inlet tube adapted to extend along the bore of a tracheal tube substantially to its patient end.

7. An intubation detector according to claim 6, wherein said inlet tube is a stiff or malleable introducer tube.

8. An intubation detector according to claim 1, wherein the detector has a stem adapted to fit in the machine end of an endotracheal tube.

9. An intubation detector arranged for mounting with a tracheal tube, wherein the detector comprises: an introducer tube, said introducer tube being adapted to extend along said tracheal tube and to open towards a patient end of said tracheal tube; a pump, said pump being mounted at a machine end of said introducer tube to apply a negative pressure to said introducer tube and to indicate when gas fills said pump from a patient end of said tracheal tube; and a carbon dioxide indicator, said carbon dioxide indicator being arranged to provide a color-change indication of presence of carbon dioxide in gas drawn into said introducer tube by said pump.

10. An intubation detector comprising: a coupling adapted to couple with the bore of a machine end of a tracheal tube; a pump, said pump being arranged to apply a negative pressure to said tube via said coupling and to indicate when gas fills said pump from a patient end of said tube; and a carbon dioxide indicator, said carbon dioxide indicator being arranged to provide a color-change indication of presence of carbon dioxide in gas drawn into said tube by said pump.

11. An assembly of an endotracheal tube and a detector, wherein the detector comprises: a pump, said pump being arranged towards a machine end of said tube to apply a negative pressure to said tube and to indicate when gas fills said pump from a patient end of said tube; and a carbon dioxide indicator, said carbon dioxide indicator being arranged to provide an indication of the presence of carbon dioxide in gas drawn into said tube by said pump.

12. An assembly according to claim 11, wherein the detector is mounted at the machine end of an introducer tube, and wherein the introducer tube extends along said endotracheal tube substantially to a patient end of said endotracheal tube.

13. An assembly according to claim 11, wherein the detector includes a stem plugged into a machine end of said endotracheal tube.

14. A method of detecting correct intubation of a tracheal tube comprising the steps of: applying a negative pressure to said tube when in position; monitoring a response to the negative pressure to determine whether a patient end of said tube is open or occluded; and monitoring a response of a carbon dioxide detector to see if said detector indicates the presence of carbon dioxide at levels found in exhaled breath.

15. A method according to claim 14, wherein the negative pressure is applied by releasing a resilient member.

16. A method according to claim 14, wherein said carbon dioxide detector is monitored for a change in color.

17. A method according to claim 14, wherein said carbon dioxide detector and a negative pressure device are mounted with an introducer extending within said tracheal tube, and wherein said introducer is removed from said tube following confirmation of correct intubation.
